(19) United States
(12) Patent Application Publication
(10) Pub. No.: US 2019/0173827 A1
(43) Pub. Date: Jun. 6, 2019

(54) DYNAMIC OPEN GRAPH MODULE FOR POSTING CONTENT ONE OR MORE PLATFORMS

(71) Applicant: Trusted Voices, Inc., Valley Village, CA (US)

(72) Inventors: Benjamin ROLLING, Valley Village, CA (US); Ian STARNES, San Clemente, CA (US)

(73) Assignee: Trusted Voices, Inc., Valley Village, CA (US)

(21) Appl. No.: 15/829,121

(22) Filed: Dec. 1, 2017

(51) Int. Cl. H04L 12/58; G06F 17/30

(52) U.S. Cl. CPC H04L 51/32; G06F 17/30887

(57) ABSTRACT

A computer-implemented method for posting content from an external source and onto one or more platforms includes receiving content from a computing device and analyzing the content to generate rich metadata. The method also includes rendering the content in one or more formats acceptable to the one or more platforms. The method further includes transmitting a uniform resource location (URL) for the rendered content to the one or more platforms to allow the one or more platforms to post the rendered content by way of the URL.

### FIELD

The present invention relates to online social media, and more particularly, posting of content from an external source and onto one or more social media platforms.

### BACKGROUND

Current platforms that post content to social media platforms fail to recognize which platform is posting to. Further, the current platforms take the received content, and post the received content into the platform without modifying the format and/or metadata. These platforms also fail to consider the type of content that is viewed by users of a social media platform. Furthermore, this content fails to include metadata that helps the content to be identified and curated.

Some technologies utilize short uniform resource locators (URLs) to deliver content and capture click throughs. This does not, however, correct the problem of delivering the right kind of content for the platform and audience. This approach also creates additional complications with analytics and corrupts the source of the content for most platforms.

Thus, an alternative process for identifying the appropriate platform may be more beneficial.

### SUMMARY

Certain embodiments of the present invention may provide solutions to the problems and needs in the art that have not yet been fully identified, appreciated, or solved by current social media platforms. For example, some embodiments generally pertain to posting content from an external source and onto one or more social media platforms.

In an embodiment, a computer-implemented method may include receiving content from a computing device and analyzing the content to generate rich metadata. The method also includes rendering the content in one or more formats acceptable to the one or more platforms. The method further includes transmitting a uniform resource location (URL) for the rendered content to the one or more platforms to allow the one or more platforms to post the rendered content by way of the URL.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a workflow illustrating a dynamic open graph (DOG) platform for sharing content to external social platforms, according to an embodiment of the present invention.

FIG. 2 is a workflow illustrating media consumption for a document, according to an embodiment of the present invention.

FIG. 3 is a workflow illustrating media consumption for a map, according to an embodiment of the present invention.

FIG. 4 is a workflow illustrating media consumption for an image, according to an embodiment of the present invention.

FIG. 5 is a workflow illustrating media consumption for media, according to an embodiment of the present invention.

FIG. 6 is a workflow illustrating media consumption for a news article, according to an embodiment of the present invention.

FIG. 7 is a workflow illustrating media consumption for social media, according to an embodiment of the present invention.

FIG. 8 is a workflow illustrating media consumption for a video, according to an embodiment of the present invention.

FIG. 9 is a workflow illustrating media consumption for a YouTube™ video, according to an embodiment of the present invention.

FIG. 10 is a block diagram illustrating a computing system, according to an embodiment of the present invention.

### DETAILED DESCRIPTION OF THE EMBODIMENTS

“Posting” content onto a social media platform has long been the norm. To handle posting or displaying of external content in a social media platform, the social media platform outlines metadata such as “open graph” or their own proprietary metadata. This metadata not only adds context such as author, content type, etc., but also instructs the platform how to display the content.

Each platform may require a combination of metadata to display the content correctly. This combination may include truthful analytics, dynamic content, automated intelligent tagging, video tagging, live video conversation analysis, and the availability to override graph data.

Truthful Analytics

Platforms may use metadata to identify the original source, causing incorrect analytics. For example, the engine may insert a different source when the platform is requesting the content for metadata versus when the platform is being requested for rendering.

Dynamic Content

Content is automatically rendered and cached into different formats, so the best content format is available for the requesting platform.

Automated Intelligent Tagging

Content tags are generated by machine learning and computer vision. By combining known context of the content from the supplied metadata and applying computer vision interpretation through a machine learning engine, we can come up with more “trusted” information about the content that can be used for both internal and external keyword/tag generation.

Video Tagging

Video tagging may include an algorithm that intelligently analyzes video frames for sufficient changes before performing the automated intelligent tagging. These changes typically involve major KEYFRAME deltas. This may be critical in the real-time nature of social media posting where time is critical. This also lends great importance to the easy consumption and distribution of live video streams for later consumption.

Live Video Conversation Analysis

By analyzing a social media conversation around a live stream in conjunction with voice to text and computer vision based machine learning, small, easy to consume clips may be created in close to real-time of live events and automatically post those.

Ability to Override Graph Data

By hosting the graph data directly, the engine allows an operator to replace default image, description, keywords, and destination uniform resource locator (URL) in the hosted graph data without requiring a change on the destination URL's page source.

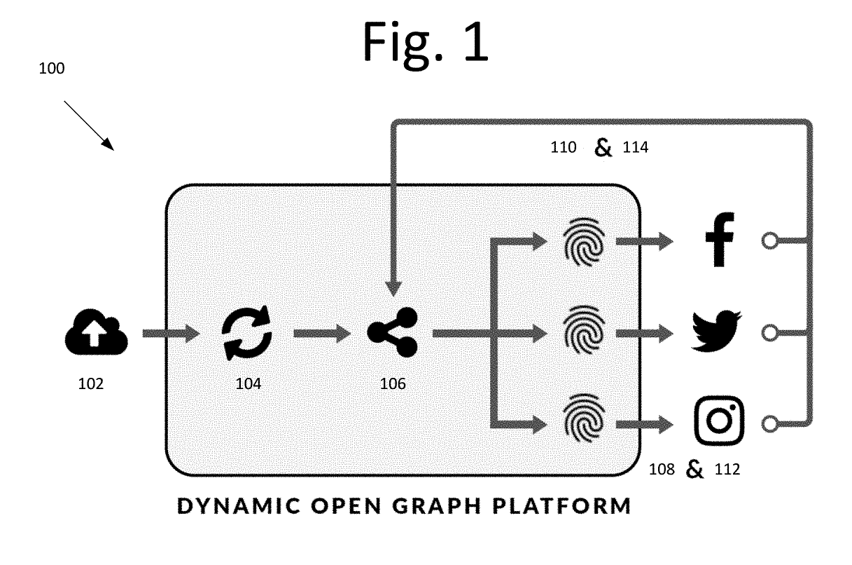

FIG. 1 is a workflow diagram 100 illustrating a DOG platform for sharing content to external social platforms, according to an embodiment of the present invention. In workflow 100, a user uploads content to the DOG platform at 102. In response, the DOG platform performs intelligent media consumption at 104.

Intelligent media consumption may provide two functions. First, the incoming content is analyzed to automatically generate rich metadata. Second, the content in various formats is rendered to allow the most appropriate format per social platform and audience to be delivered. Analyzing the content and generating rich metadata via machine learning allows for users to quickly post content without having to worry about filling in metadata.

At 106, the content is shared to external social platforms, such as Facebook™, Twitter™, LinkedIn™, etc., by way of the DOG platform. At 108, the DOG platform generates a unique content URL for each platform, and posts the unique content URL to each platform.

At 110, the DOG platform analyzes the incoming requests using the unique content URLS. These requests may be from a platform, such as Twitter™, attempting to parse the graph data for this content, or a user clicking the content on a platform, such as Twitter™, to view the content.

At 112, the DOG platform returns the most optimal open graph data for the requesting external social platform. For example, the DOG platform may determine that the content being requested from a platform, such as Facebook™, would be best delivered as a video. However, for another platform such as Twitter™, the DOG platform may determine that the same content should be delivered as an animated GIF. In other words, the DOG platform may deliver different content and graph data based on the requesting platform. In another embodiment, when a user attempts to view the content with the same URL, the DOG platform may redirect the user to the social media platform that is most suitable for his or her device. This way, the user can view the content that is most suitable for his or her device (e.g., mobile, desktop, etc.).

At 114, the DOG platform continuously monitors externally shared content via “live conversation analysis”. For example, the DOG platform may analyze the “conversation” such as comments, likes, reshares, retweets, and moods. This analysis determines how well content is being accepted, and allows operators to change the tone and subject of future posts based on that feedback. The feedback may be provided using raw data or provided using suggestions made through the interface.

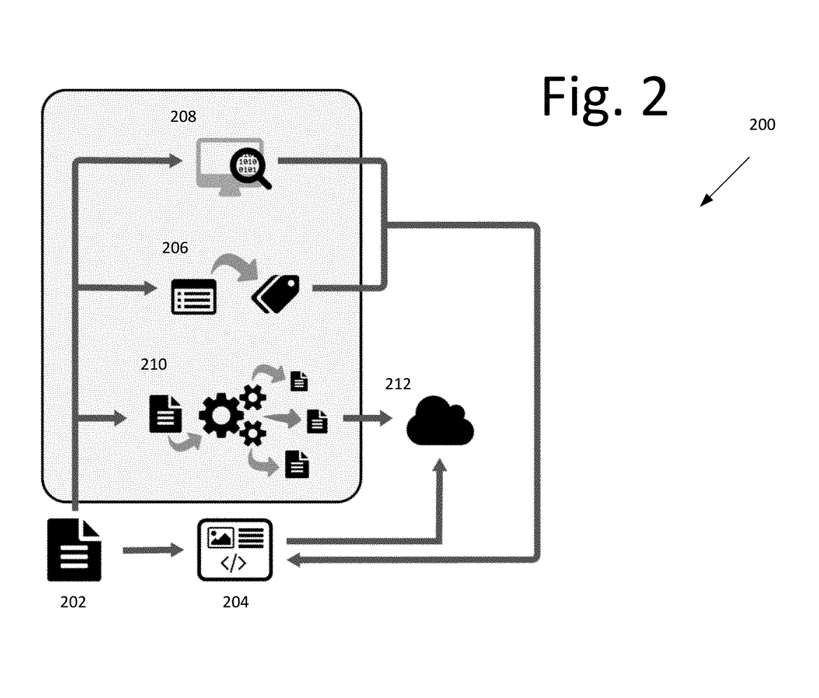

FIG. 2 is a workflow 200 illustrating media consumption for a document, according to an embodiment of the present invention. In this embodiment, workflow 200 may begin at 202 with identifying and integrating the media for “document” type. At 204, the content container is generated. In some embodiments, the content container provides an overarching container for the content and all the sub-content that may be generated from it.

At 206, the metadata is extracted for title, author, location, type, keywords, etc. At 208, the extracted media is run through object detection and facial recognition. It should be noted that analyzing the content and generating rich metadata via machine learning allows for users to quickly post content without having to worry about filling in metadata. This metadata can be crucial in understanding the correct audience for the type of content before posting, and analyzing how posted content has performed and why.

At 210, the PDF and thumbnail renditions are generated, and at 212, the renditions are pushed to a content delivery network (CND) for faster delivery to the end user. Referring to 210, the document is converted into PDF, HTML, and various size thumbnail images for each page. These renditions are pushed to a CDN for faster delivery to the end user. This allows the user to quickly post the content in the future without having to generate these renditions when posting to social media platforms.

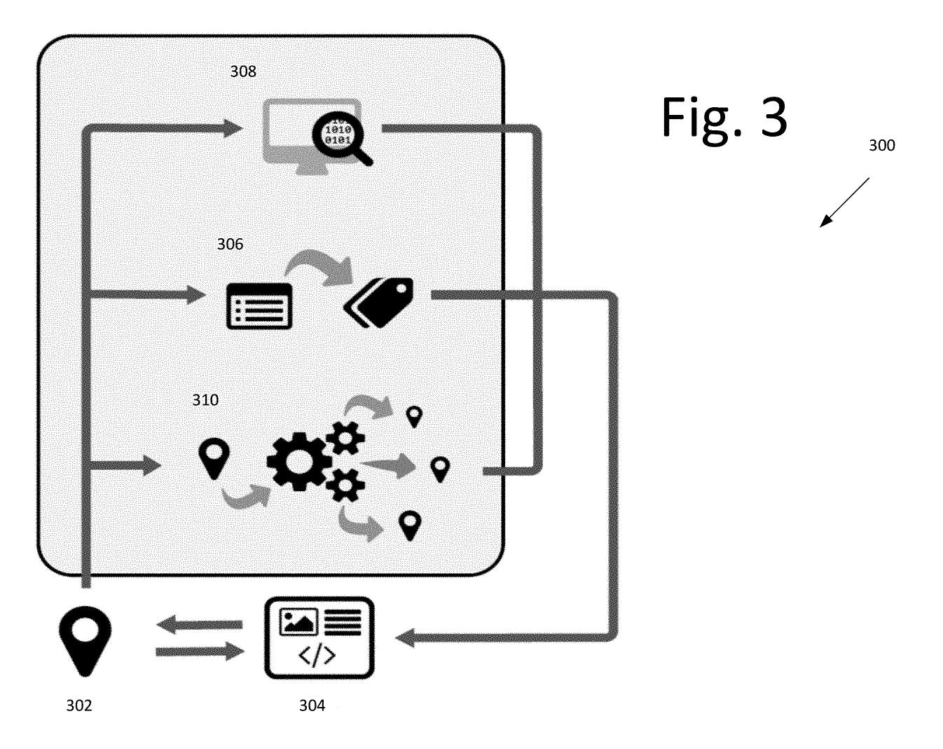

FIG. 3 is a workflow 300 illustrating media consumption for a map, according to an embodiment of the present invention. In this embodiment, workflow 300 may begin at 302 with identifying and integrating the media for “map” type such as Google™ maps. At 304, a content container is generated, and at 306, metadata is extracted for title, author, location, type, keywords, etc. At 308, a geolocation meta engine is ran for details on location, local businesses, parks, etc. Location may be defined by categories, airports, parks, store, restaurants, etc. Facial recognition and object detection are also performed on images contained within the extracted metadata. At 310, a mini map thumbnail of the location is generated. In some embodiments, up to 20 local images are retrieved from Google™ and rendered into various sizes and formats.

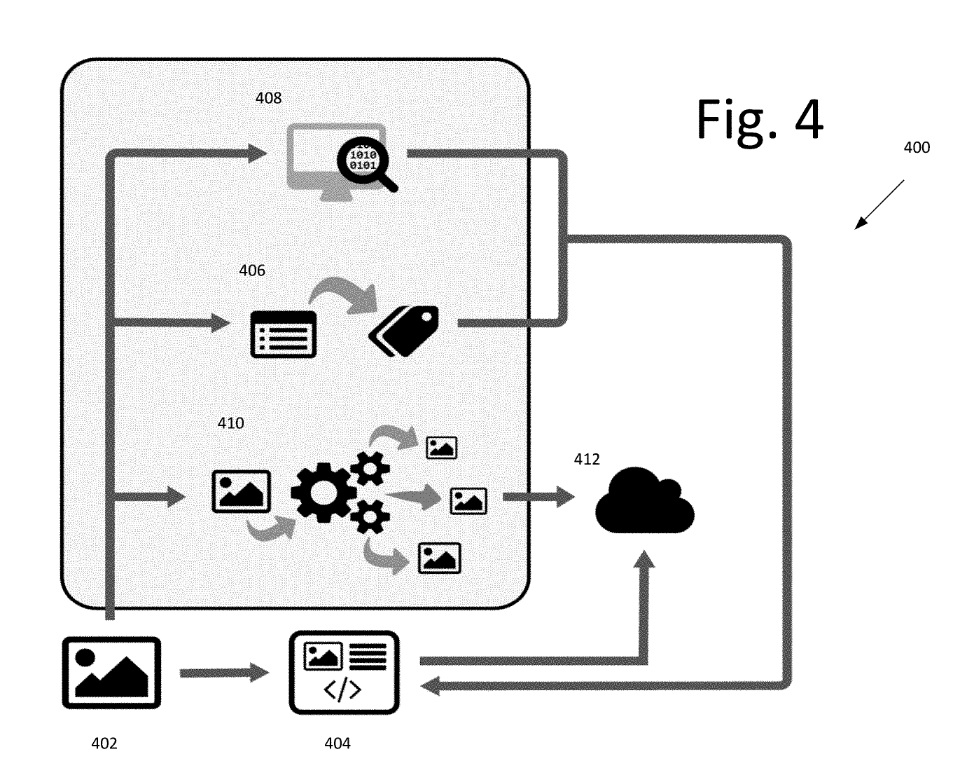

FIG. 4 is a workflow 400 illustrating media consumption for an image, according to an embodiment of the present invention. In this embodiment, workflow 400 may begin at 402 with identifying and integrating media for an “image” type. At 404, a content container is generated, and at 406, metadata is extracted for title, author, location, type, keywords, etc. At 408, object detection and facial recognition are performed, and at 410, multiple renditions in different image formats and sizes are rendered. This may also include sub images of detected faces and objects. At 412, all renditions are pushed to the CDN for faster delivery to the end user.

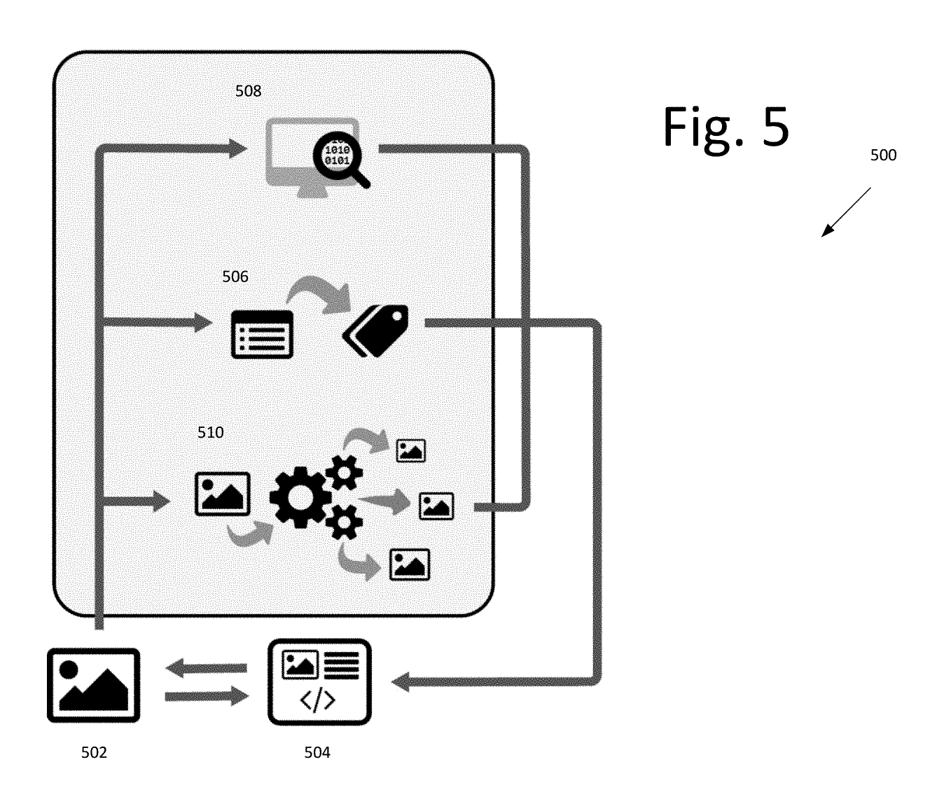

FIG. 5 is a workflow 500 illustrating media consumption for media, according to an embodiment of the present invention. In this embodiment, workflow 500 may begin at 502 with identifying and integrating media for “media” type. At 504, a content container is generated, and at 506, metadata is extracted for title, author, location, type, keywords, etc. At 508, media is fetched, and object detection and facial recognition are performed thereto. In some embodiments, the end user is linked to the source URL. At 610, one or more thumbnail renderings of the media are generated.

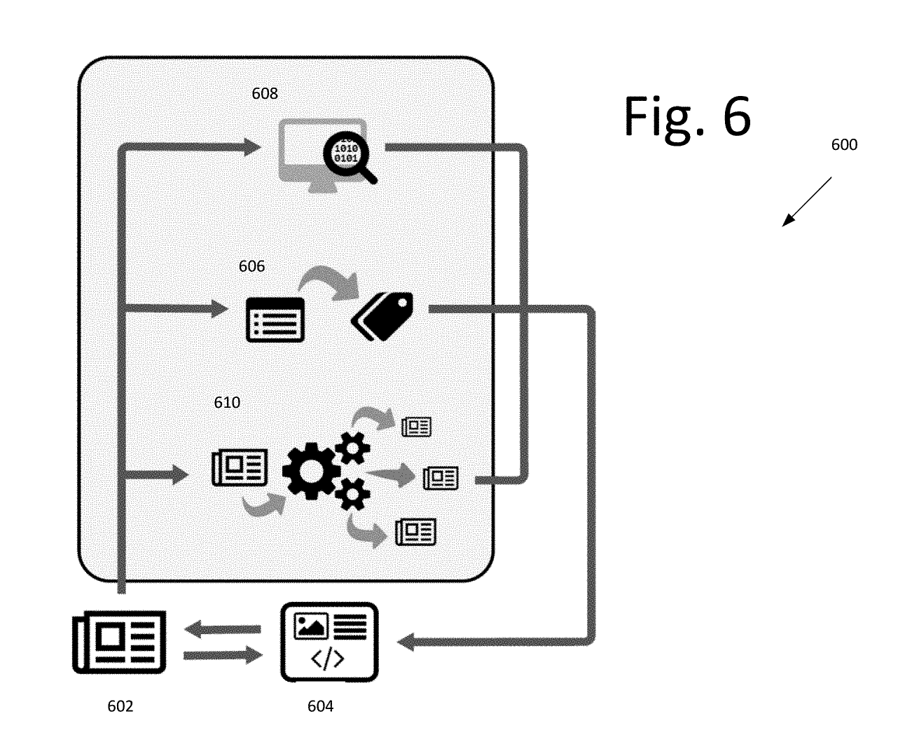

FIG. 6 is a workflow illustrating media consumption for a news article, according to an embodiment of the present invention. In this embodiment, workflow 600 may begin at 602 with identifying and integrating media for “URL” type. At 604, a content container is generated, and at 606, metadata is extracted for title, author, location, type, keywords, etc. In some embodiments, a summary may be generated if a summary does not already exist. At 608, media is extracted, and object detection and facial recognition are performed thereto. In some embodiments, the content analysis engine may determine if content matches keywords, and may generate more weighted keywords. In some further embodiments, the end user is linked to the source URL. At 610, one or more thumbnail renderings of the media are generated.

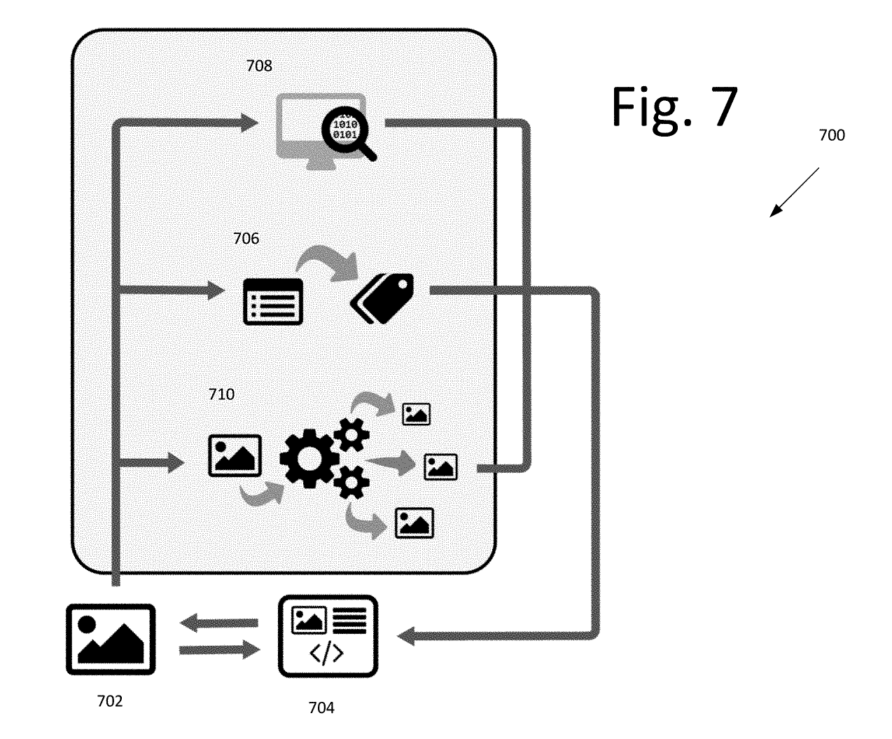

FIG. 7 is a workflow 700 illustrating media consumption for social media, according to an embodiment of the present invention. In some embodiments, workflow 700 may begin at 702 with identifying and integrating the media for “media” type. At 704, a content container is generated, and at 706, content is scraped externally. The results of which are sent through special parsers for metadata. At 708, object detection and facial recognition are performed on scraped content, and the end user is linked to the source URL. At 710, one or more thumbnail renders of scraped content are generated.

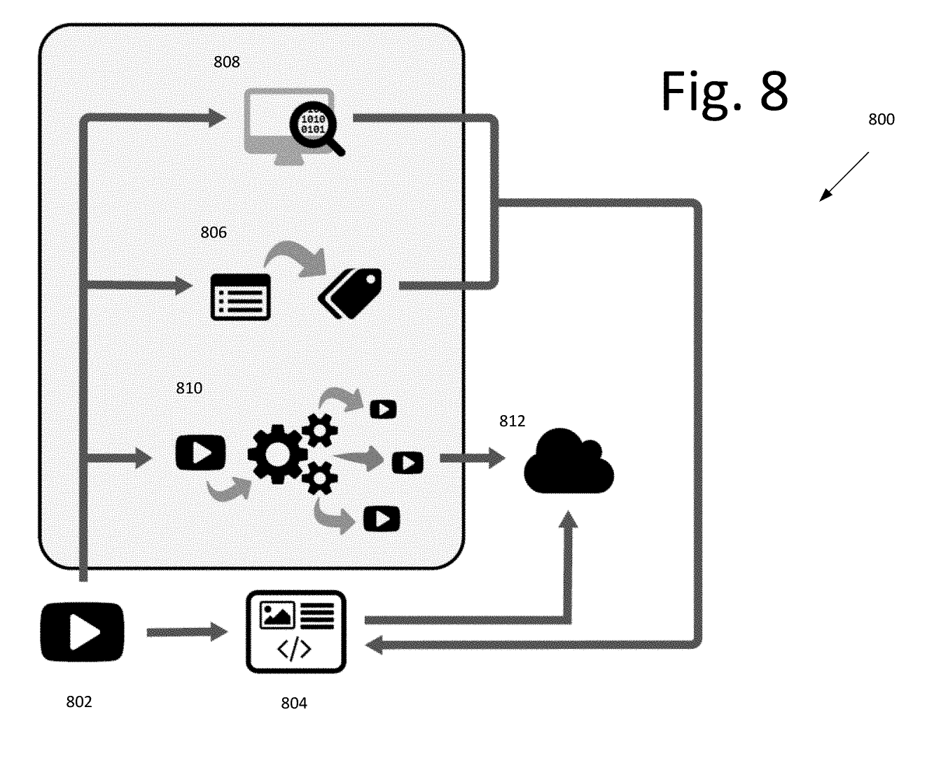

FIG. 8 is a workflow 800 illustrating media consumption for a video, according to an embodiment of the present invention. In some embodiments, workflow 800 may begin at 802 with identifying and integrating media for “video” type. At 804, a content container is generated, and at 806, metadata is extracted for title, author, location, type, keywords, etc. At 808, location (if available) is analyzed by way of a geolocation meta engine. At every major keyframe change, the frame is analyzed for computer video object detection. For example, one or more objects may be given weight by percentage of appearance, confidence in detection, and objects of similar categories, and facial detection is performed to detect “actors” or famous people. At 810, animated GIFS are generated for up to 60 seconds of video. In some embodiments, multiple quality and formats of video renditions are generated. Every major keyframe change generates a “preview thumbnail” for scrubbing. At 812, all renditions are pushed to the CDN for faster delivery to the end user.

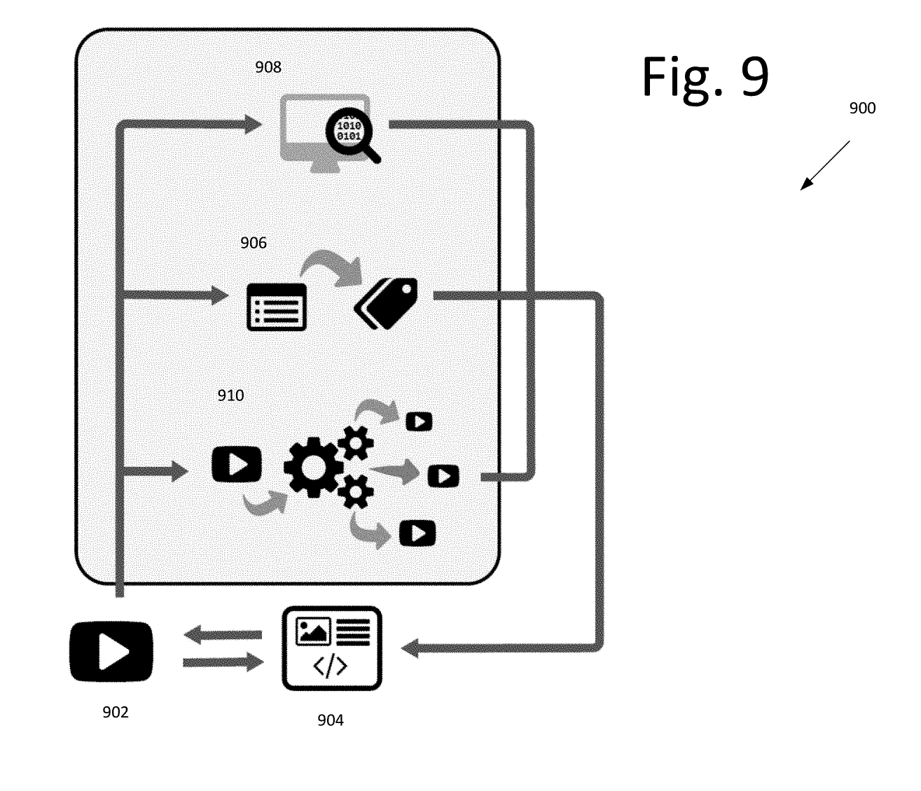

FIG. 9 is a workflow 900 illustrating media consumption for a YouTube™ video, according to an embodiment of the present invention. In some embodiments, workflow 900 may begin at 902 with identifying and integrating media for “video” type. At 904, a content container is generated, and at 906, metadata is extracted for title, author, location, type, keywords, etc. At 908, video is fetched and object detection and facial recognition are run. In some embodiments, end user playback is linked to the source URL. At 910, thumbnail renders of fetched video are generated.

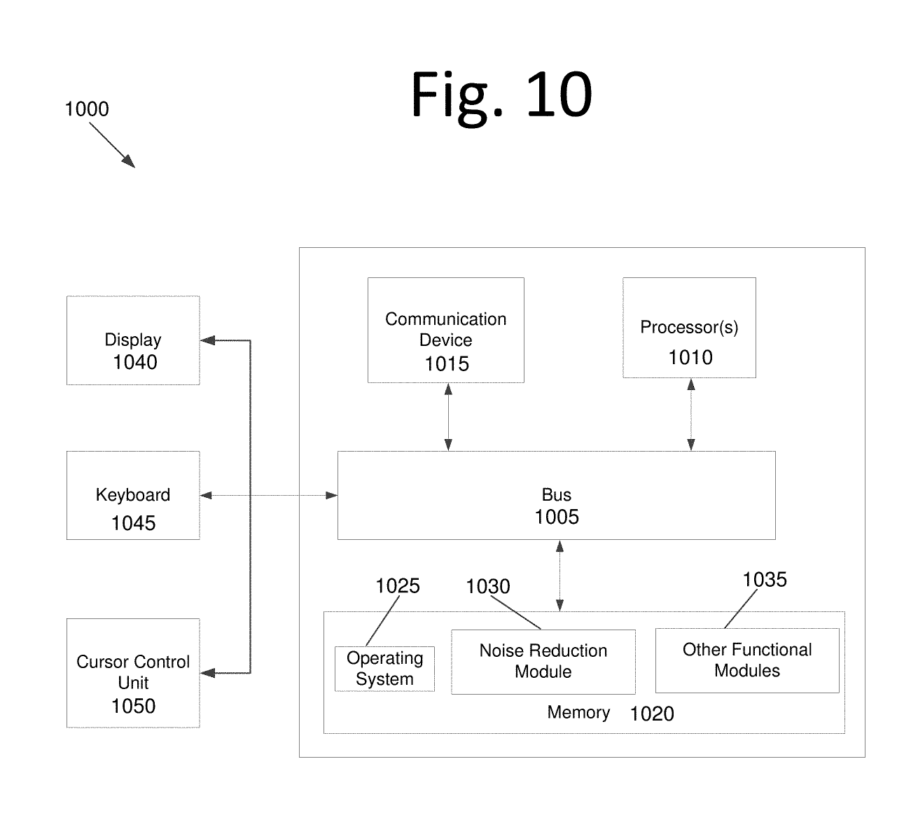

FIG. 10 is a block diagram illustrating a computing system 1000, according to an embodiment of the present invention. Computing system 1000 may include a bus 1005 or other communication mechanism configured to communicate information, and at least one processor 1010, coupled to bus 1005, configured to process information. At least one processor 1010 can be any type of general or specific purpose processor. Computing system 1000 may also include memory 1020 configured to store information and instructions to be executed by at least one processor 1010. Memory 1020 can be comprised of any combination of random access memory (“RAM”), read only memory (“ROM”), static storage such as a magnetic or optical disk, or any other type of computer readable medium. Computing system 1000 may also include a communication device 1015, such as a network interface card, configured to provide access to a network.

The computer readable medium may be any available media that can be accessed by at least one processor 1010. The computer readable medium may include both volatile and nonvolatile medium, removable and non-removable media, and communication media. The communication media may include computer readable instructions, data structures, program modules, or other data and may include any information delivery media.

At least one processor 1010 can also be coupled via bus 1005 to a display 1040, such as a Liquid Crystal Display (“LCD”). Display 1040 may display information to the user. A keyboard 1045 and a cursor control unit 1050, such as a computer mouse, may also be coupled to bus 1005 to enable the user to interface with computing system 1000.

According to one embodiment, memory 1020 may store software modules that may provide functionality when executed by at least one processor 1010. The modules can include an operating system 1025 and DOG module 1030, as well as other functional modules 1035. Operating system 1025 may provide operating system functionality for computing system 1000. Because computing system 1000 may be part of a larger system, computing system 1000 may include one or more additional functional modules 1035 to include the additional functionality.

One skilled in the art will appreciate that a “system” could be embodied as a personal computer, a server, a console, a personal digital assistant (PDA), a cell phone, a tablet computing device, or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Some embodiments of the present invention generally pertain to matching and generating one or more types of media from content. Content may be shared by another user of the platform to another social platform, such as Facebook. Upon sharing the content, a request (or a request back) is submitted to the other social platform for the shared content. In one embodiment, the request is for raw content. Upon receiving the raw data, the raw data is scraped to identify the platform and the best open graph data (or metadata). The identified open graph data instructing the platform on how to show the content and the type of media to be used to show the content.

It will be readily understood that the components of various embodiments of the present invention, as generally described and illustrated in the figures herein, may be arranged and designed in a wide variety of different configurations. Thus, the detailed description of the embodiments, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer-implemented method for posting content from an external source and onto one or more platforms, comprising:
receiving content from a computing device;
analyzing the content to generate rich metadata;
rendering the content in one or more formats acceptable to the one or more platforms; and
transmitting a uniform resource location (URL) for the rendered content to the one or more platforms to allow the one or more platforms to post the rendered content by way of the URL.

2. The computer-implemented method of claim 1, further comprising:
generating a URL for each of the one or more platforms.

3. The computer-implemented method of claim 1, further comprising:
receiving an incoming request to access the rendered content from the one or more platforms using the URL.

4. The computer-implemented method of claim 3, further comprising:
analyzing the incoming request comprising the URL for the rendered content to determine medium in which to deliver the content.

5. The computer-implemented method of claim 4, wherein the medium to deliver content comprises a video, an image, audio, or any combination thereof.

6. The computer-implemented method of claim 4, further comprising:
redirecting a user of the computing device to a platform most suitable for the computing device.

7. The computer-implemented method of claim 1, further comprising:
continuously monitoring externally shared content on the one or more platforms to determine if the content is being accepted.

8. A computer program embodied on a non-transitory computer readable medium, the computer program is configured to cause at least one processor to:
receive content from a computing device;
analyze the content to generate rich metadata;
render the content in one or more formats acceptable to the one or more platforms; and
transmit a uniform resource location (URL) for the rendered content to the one or more platforms to allow the one or more platforms to post the rendered content by way of the URL.

9. The computer program of claim 8, wherein the computer program is further configured to cause the at least one processor to:
generate a URL for each of the one or more platforms.

10. The computer program of claim 8, wherein the computer program is further configured to cause the at least one processor to:
receive an incoming request to access the rendered content from the one or more platforms using the URL.

11. The computer program of claim 10, wherein the computer program is further configured to cause the at least one processor to:
analyze the incoming request comprising the URL for the rendered content to determine medium in which to deliver the content.

12. The computer program of claim 11, wherein the medium to deliver content comprises a video, an image, audio, or any combination thereof.

13. The computer program of claim 11, wherein the computer program is further configured to cause the at least one processor to:
redirect a user of the computing device to a platform most suitable for the computing device.

14. The computer program of claim 8, wherein the computer program is further configured to cause the at least one processor to:
continuously monitor externally shared content on the one or more platforms to determine if the content is being accepted.

15. An apparatus for posting content from an external source and onto one or more platforms, comprising:
at least one processor; and
memory comprising a set of instructions, wherein
the set of instructions is configured to cause the at least one processor to
receive content from a computing device;
analyze the content to generate rich metadata;
render the content in one or more formats acceptable to the one or more platforms; and
transmit a uniform resource location (URL) for the rendered content to the one or more platforms to allow the one or more platforms to post the rendered content by way of the URL.

16. The apparatus of claim 15, wherein the set of instructions are further configured to cause at least the one processor to:
generate a URL for each of the one or more platforms.

17. The apparatus of claim 15, wherein the set of instructions are further configured to cause at least the one processor to:
receive an incoming request to access the rendered content from the one or more platforms using the URL.

18. The apparatus of claim 17, wherein the set of instructions are further configured to cause at least the one processor to:
analyze the incoming request comprising the URL for the rendered content to determine medium in which to deliver the content.

19. The apparatus of claim 18, wherein the medium to deliver content comprises a video, an image, audio, or any combination thereof.

20. The apparatus of claim 18, wherein the set of instructions are further configured to cause at least the one processor to:
redirect a user of the computing device to a platform most suitable for the computing device.

21. The apparatus of claim 15, wherein the set of instructions are further configured to cause at least the one processor to:
continuously monitor externally shared content on the one or more platforms to determine if the content is being accepted.
